(19) United States
(12) Patent Application Publication
(10) Pub. No.: US 2024/0330546 A1
(43) Pub. Date: Oct. 3, 2024

(54) COMPUTER IMPLEMENTED SYSTEMS, SOFTWARE, AND METHODS FOR DENTAL PROSTHETIC DESIGN AND EVALUATION USING RISK ANALYSIS

(71) Applicant: Sven Bone, Bozeman, MT (US)

(72) Inventor: Sven Bone, Bozeman, MT (US)

(21) Appl. No.: 18/623,788

(22) Filed: Apr. 1, 2024

Related U.S. Application Data
(60) Provisional application No. 63/493,417, filed on Mar. 31, 2023.

(51) Int. Cl. G06F 30/27; A61C 13/00; A61C 13/34

(52) U.S. Cl. CPC G06F 30/27; A61C 13/0004; A61C 13/34

(57) ABSTRACT

A computing system and method are for analyzing risks of potential mechanical problems of dental prostheses. The approach includes hardware processors and associated memory configured by machine-readable instructions to access 3D data regarding a dental prostheses for a patient, receive patient specific parameters for the patient, perform a simulation of stresses and fatigue on the dental prostheses based upon the 3D data and patient specific parameters, generate a risk analysis of the potential mechanical problems of the dental prostheses based upon the simulation of stresses, and output results of the risk analysis to a user to improve prosthetic design and materials selection, and manage quality control errors in manufacturing, which reduce the risk of mechanical problems. An object may be to provide a large database for use in Artificial Intelligence(AI)/machine learning driven Dental CAD design software. This database will aid in AI Dental CAD design software to design prostheses that will conform to the user's preferences and also have low risk of mechanical failure.

### RELATED APPLICATIONS

This application claims priority to U.S. Provisional Application Ser. No. 63/493,417 filed Mar. 31, 2023 titled “COMPUTER IMPLEMENTED SYSTEMS, SOFTWARE, AND METHODS FOR DENTAL PROSTHETIC DESIGN AND EVALUATION USING FINITE ELEMENT ANALYSIS” which is incorporated herein in its entirety by reference.

### FIELD OF THE INVENTION

The present invention relates to systems, software applications, and methods for computer networks, and more specifically for dental prosthetic design and evaluation using risk analysis.

### BACKGROUND

Dental prosthetics refer to the artificial replacements for missing or damaged teeth, which can restore dental function and improve esthetics. The field of dental prosthetics has a long history, dating back to ancient civilizations such as the Etruscans and the Egyptians, who used various materials such as gold, ivory, and human teeth to create dental prostheses.

Modern dental prosthetics have come a long way since then, with advances in materials science, computer-aided design (CAD) and manufacturing (CAM) techniques, and digital imaging technologies. Today, dental prosthetics can be fabricated from a range of materials, including ceramics, polymers, and metals, and can be customized to fit each patient's unique needs and preferences.

There are several types of dental prostheses available, including fixed prostheses such as dental bridges and dental crowns, and removable prostheses such as complete or partial dentures. Dental implants, which are artificial tooth roots made of titanium or other materials that are surgically placed into the jawbone, have also become increasingly popular in recent years. Dental implants serve as anchor points for dental prostheses to either fix them in place or increase their retention.

The design and fabrication of dental prostheses is a complex process that requires careful consideration of several factors, including the patient's oral health, the type and location of the missing or damaged teeth, and the desired esthetic outcome. CAD/CAM technologies have revolutionized the field of dental prosthetics, allowing for more precise and accurate prosthetic design and fabrication.

Despite these advances, dental prosthetics can still pose certain challenges, such as the risk of mechanical failure due to material fatigue or inadequate design. Overall, dental prosthetics are an important component of modern dental care, providing patients with a range of options for restoring dental function and esthetics. Ongoing research and development in this field promise to further improve the quality and longevity of dental prostheses, benefiting millions of patients around the world.

Advanced software systems can play a crucial role in improving the accuracy and safety of dental prosthetic design and analysis.

### SUMMARY

The present application discloses embodiments including and/or related to computer implemented systems, methods, and apparatus that utilizes (e.g. finite element analysis) techniques to simulate stresses and fatigue imposed by the stomatognathic system on dental implants, dental implant components, prosthetic components, and dental prostheses, and provides a risk analysis of potential mechanical failure. The software receives 3D data (e.g. .stl or other 3D mesh formats) as input, and incorporates patient-specific parameters to generate a comprehensive risk analysis report. In addition, the software may be used for quality control analysis by manufacturers of dental prostheses. The software may detect errors in the manufactured prostheses (i.e. distortions) that occur in the manufacturing process and provide further comprehensive risk analysis of the actual finished prostheses. Therefore, the software may provide comprehensive risk analysis for potential mechanical failure of both CAD designed dental prostheses and their subsequent manufactured counterpart.

In a first aspect, a computing system to analyze risks of potential mechanical problems of dental prostheses is provided. The system includes one or more hardware processors and associated memory configured by machine-readable instructions. Execution of the machine readable instructions by the processor of the computer system may perform functions. The functions can be configured to: access 3D data regarding a dental prostheses for a patient; receive patient specific parameters for the patient; perform a simulation of stresses and fatigue on the dental prostheses based upon the 3D data and patient specific parameters; generate a risk analysis of the potential mechanical problems of the dental prostheses based upon the simulation of stresses; and output results of the risk analysis to a user to improve prosthetic design and materials selection, and manage quality control errors in manufacturing, which reduce the risk of mechanical problems.

Additionally and/or alternatively, performing the simulation of stresses and fatigue on the dental prostheses comprises a finite element analysis (FEA) technique.

Additionally and/or alternatively, the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, location/orientation of the dental prosthesis in relation to anatomical structures of the patient.

Additionally and/or alternatively, the FEA technique further uses internal parameters including mechanical properties of bone, teeth and materials.

Additionally and/or alternatively, generating the risk analysis includes generating a risk value on a probability scale of mechanical failure.

Additionally and/or alternatively, outputting results of the risk analysis further includes outputting corrective solutions and displaying quality control errors in manufacturing.

Additionally and/or alternatively, the corrective solutions include presenting alternative materials with lower risk values, suggesting dental prosthesis design changes, and displaying distortions in a finished dental prosthesis compared to a corresponding designed dental prosthesis.

Another aspect is directed to a method to analyze risks of potential mechanical problems of dental prostheses, using one or more hardware processors and associated memory configured by machine-readable instructions. The method includes: accessing 3D data regarding a dental prostheses for a patient; receiving patient specific parameters for the patient; performing a simulation of stresses and fatigue on the dental prostheses based upon the 3D data and patient specific parameters; generating a risk analysis of the potential mechanical problems of the dental prostheses based upon the simulation of stresses and fatigue; and outputting results of the risk analysis to a user to improve prosthetic design and materials selection, and reduce the risk of mechanical problems.

Additionally and/or alternatively, performing the simulation of stresses and fatigue on the dental prostheses comprises a finite element analysis (FEA) technique.

Additionally and/or alternatively, the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, location/orientation of the dental prostheses in relation to anatomical structures of the patient.

Additionally and/or alternatively, the FEA technique further uses internal parameters including mechanical properties of bone, teeth and materials.

Additionally and/or alternatively, generating the risk analysis includes generating a risk value on a probability scale of mechanical failure.

Additionally and/or alternatively, outputting results of the risk analysis further includes outputting corrective solutions and displaying quality control errors in manufacturing.

Additionally and/or alternatively, the corrective solutions include presenting alternative materials with lower risk values, suggesting dental prosthesis design changes, and displaying distortions in a finished dental prosthesis compared to a corresponding designed dental prosthesis.

Another aspect is directed to a non-transitory computer-readable memory having stored therein instructions executable by a processor to cause a computing system to perform functions. The functions include: accessing 3D data regarding a dental prostheses for a patient; receiving patient specific parameters for the patient; performing a simulation of stresses and fatigue on the dental prostheses based upon the 3D data and patient specific parameters; generating a risk analysis of the potential mechanical problems of the dental prostheses based upon the simulation of stresses and fatigue; and outputting results of the risk analysis to a user to improve prosthetic design and materials selection, and reduce the risk of mechanical problems.

Additionally and/or alternatively, performing the simulation of stresses and fatigue on the dental prostheses comprises a finite element analysis (FEA) technique.

Additionally and/or alternatively, the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, and location/orientation of the dental prostheses in relation to a temporomandibular joint of the patient.

Additionally and/or alternatively, the FEA technique further uses internal parameters including mechanical properties of bone, teeth and materials.

Additionally and/or alternatively, generating the risk analysis includes generating a risk value on a probability scale of mechanical failure and displaying quality control errors in manufacturing.

Additionally and/or alternatively, outputting results of the risk analysis further includes outputting corrective solutions that include presenting alternative materials with lower risk values, suggesting dental prosthesis design changes, and displaying distortions in a finished dental prosthesis compared to a corresponding designed dental prosthesis.

Thus, the embodiments provide a comprehensive approach for designing and manufacturing by analyzing dental prostheses using advanced software techniques, improving patient outcomes and reducing the risk of prosthetic failure.

### BRIEF DESCRIPTION OF THE DRAWINGS

The figures which accompany the written portion of this specification illustrate embodiments and method(s) of use according to the teachings of the present invention.

FIG. 1 is a schematic block diagram illustrating the components of a computing device according to an embodiment of the present invention.

FIG. 2 is a block diagram of a computing system configured for providing the risk analysis of potential mechanical problems of dental prostheses, in accordance with the example embodiments.

FIG. 3 is a flowchart illustrating the system and process architecture flowchart according to an embodiment of the present invention.

The figures are schematic, not necessarily to scale, and generally only shows parts which are necessary to elucidate example embodiments, wherein other parts can be omitted or merely suggested.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of example systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using various components, hardware, electronic hardware, computer software, or any combination thereof. Whether such elements are implemented as hardware or software depends upon the particular application and design constraints imposed on the overall system.

Objectives of the embodiments of the invention may include: providing patient specific risk assessment of potential mechanical failures for dental prostheses; providing benchmarking for bioengineering certification of dental prostheses; providing benchmarking for research in new dental materials and devices; providing benchmarking for dental prostheses warranties to patients; and providing a large database for use in Artificial Intelligence(AI)/machine learning driven Dental CAD design software. This database will aid in AI Dental CAD design software to design prostheses that will conform to the user's preferences and also have low risk of mechanical failure.

FEA stands for Finite Element Analysis, which is a computer-based numerical technique used to simulate and analyze the behavior of structures and components under various loading conditions. An FEA simulation involves dividing a complex geometry into smaller, simpler elements, and then applying mathematical models to calculate the stress, strain, displacement, and other relevant physical properties of each element.

The FEA simulation takes into account the material properties, boundary conditions, and loading conditions of the structure or component being analyzed, and can provide valuable insights into its performance and behavior. FEA simulations are commonly used in engineering fields such as mechanical, civil, aerospace, and biomedical engineering, to predict the behavior of structures and components under real-world operating conditions.

In the context of dental prosthetics, FEA simulations can be used to predict the stresses and strains that will be imposed on the prosthetic structure when it is subjected to various loading conditions, such as biting and chewing. This information can be used to optimize the design and material selection of the prosthetic structure, and to minimize the risk of mechanical failure or other adverse effects.

### Dental Prosthetic Design and Evaluation System and Method

Dental Prosthesis Mechanical Failure Risk Analysis System/Method (Software) may include FEA simulation: 1-Provide model geometry based on existing data for dental articulation and articulator design; 2-Arbitrary mounting in existing Dental CAD software can be used to relate upper jaw to the lower jaw with the horizontal hing axis; 3-Provide adaptive model using patient CBCT to further refine patient specific simulation; and 4-Provide adaptive model using patient specific jaw motion tracking data to further refine patient specific simulation.

Materials and Mechanical properties database: 1-Provide a database of materials and their corresponding mechanical properties provided by the manufacturers, scientific studies, internal mechanical testing and third party mechanical testing; and 2-Use literature based data for mechanical properties of bone and teeth.

Implant Library database: 1-Provide a database of dental implants and components provided by manufacturer; and 2—The database will include manufacturer provided CAD files, 3D mesh file formats or design files of each component and materials used.

Input Data (User data): 1-Dental CAD designed prostheses (e.g., in 3D mesh format) and, for example, mounted on a virtual articulator to be simulated; 2-Desired material for manufacturing the prostheses; 3-Dental implant number, type and location/orientation data; 4-Dental implant components used; 5-Cement or bonding agents used; 6-Biteforce data; 7-Jaw motion tracking data; 8-Prepared teeth to be used to retain the prosthesis; and 9-Cone beam CT (CBCT) Data for temporomandibular joint simulation and dental implant prosthetics systems analysis.

Simulation (Computing): 1-User defined parameters and internal parameters used to calculate stresses in a dynamic FEA model for the test prosthesis design; 2-Areas of high stress where crack formation and propagation are likely are identified; 3-Risk value is generated on probability scale of fracture or component failure; 4-Mitigation processes used to simulate alternative materials and increase material thickness at high risk areas; and 5-Detect errors in the manufactured prostheses (i.e. distortions) that occur in the manufacturing process and provide further comprehensive risk analysis of the actual finished prostheses.

Output Data: 1-Risk value for mechanical failure of prosthesis design; and 2-Mitigation solutions in the design or material selection. In addition, the software may be used for quality control analysis by manufacturers of dental prostheses.

The user interface allows the user to input data such as desired prosthetic materials, biteforce data, jaw motion tracking data, dental implant number, type and location/orientation data, implant abutments used, implant or prosthetic screws used, cement or bonding agents used, prepared teeth to be used to retain the prosthesis, and location/orientation of the CAD designed prostheses in relation to the patients temporomandibular joint. The software may also incorporate Cone beam CT (CBCT) data for dental implant prosthetics systems analysis. The user may also upload scans of the manufactured dental prosthesis for further risk analysis of the finished product.

The system utilizes both the user-input parameters and internal parameters, such as the mechanical properties of bone and teeth, to perform a finite element analysis simulation. The risk analysis algorithms identify locations of stress where crack initiation and propagation are likely, and generate a risk value on a probability scale of mechanical failure.

The software may also generate corrective solutions, such as alternative materials with lower risk values and design changes (e.g. thickening or adding more material to a high risk area). This allows the user to make informed decisions on prosthetic design, materials selection, and manufacturing process to minimize the risk of mechanical failure.

### Systems

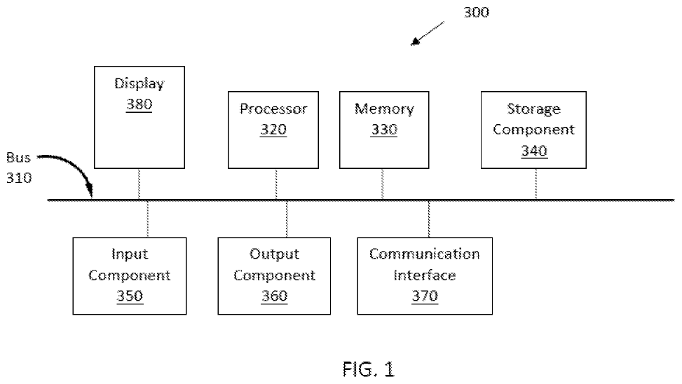

FIG. 1 illustrates an example computer system 300 to implement the Dental Prosthetic Design and Evaluation System and Method. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example, and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, an embodiment of a computing system or device 300, including a Dental Prosthetic Design and Evaluation System and Method capability in accordance with features of the present invention will be described. FIG. 1 is a diagram of example components of a device 300. As shown in FIG. 1, device 300 may include a bus 310, a processor 320, a memory 330, a storage component 340, an input component 350, an output component 360, a communication interface 370, and a display 380.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include various computer memory types such as RAM, DRAM, SDRAM, DDR, GDDR, HBM, ROM, PROM, EPROM, EEPROM, NVRAM a hard disk (e.g., a magnetic disk, an optical disk, a magneto-optic disk, a solid state disk, etc.), a compact disc (CD), a digital versatile disc (DVD), a floppy disk, a cartridge, a magnetic tape, an SSD, and/or another type of non-transitory computer-readable medium, along with a corresponding drive.

Input component 350 may include a component that permits device 300 to receive information, such as via user input (e.g., components of a touch screen display, a keyboard, a keypad, a mouse, a button, a switch, an imaging device, a microphone, etc.). Additionally, or alternatively, input component 350 may include a sensor for sensing information (e.g., a geo-location module such as a global positioning system (GPS) component, an accelerometer, a gyroscope, an actuator, etc.). Output component 360 may include a component that provides output information from device 300 (e.g., a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Display 380 may be a digital display, for example, an LCD, LED, plasma display, touch screen or any other digital display capable of communicating information including displaying video. Other visual displays are also contemplated including the use of ocular devices, virtual reality (VR), augmented reality (AR), and/or holographic displays, for example.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1 are provided as an example. In practice, device 300 may include additional components, fewer components, different components, or differently arranged components than those shown in FIG. 1. Additionally, or alternatively, a set of components (e.g., one or more components) of device 300 may perform one or more functions described as being performed by another set of components of device 300.

The input component 350, or user interface, allows the user to input data such as desired prosthetic materials, biteforce data, jaw motion tracking data, dental implant number, type and location/orientation data, implant abutments used, implant or prosthetic screws used, cement or bonding agents used, prepared teeth to be used to retain the prosthesis, and location/orientation of the prostheses (e.g. CAD designed prostheses) in relation to the patients anatomical features (e.g. temporomandibular joint). The software may also incorporate Cone beam CT (CBCT) data for dental implant prosthetics systems analysis. The user may also upload scans of the manufactured dental prosthesis for further risk analysis of the finished product.

The system 300 may utilize both the user-input parameters and internal parameters, such as the mechanical properties of bone and teeth, to perform a finite element analysis simulation. The risk analysis processes identify locations of stress where crack initiation and propagation are likely, and generate a risk value on a probability scale of mechanical failure.

The software may also generate corrective solutions, such as alternative materials with lower risk values and design changes (e.g. thickening or adding more material to a high risk area). This allows the user to make informed decisions on prosthetic design, materials selection, and manufacturing process to minimize the risk of mechanical failure.

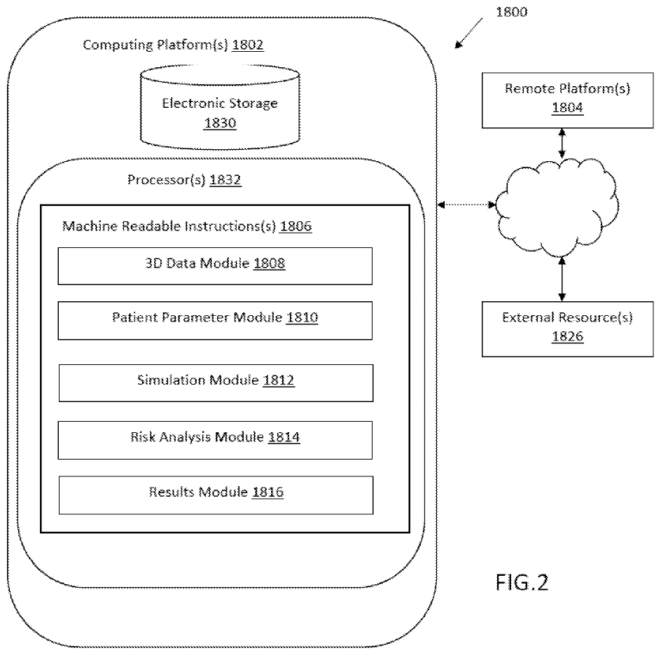

FIG. 2 is a block diagram of a computing system 1800 configured for providing the system and method for dental prosthetic design and evaluation, in accordance with the example embodiments. In some implementations, computing system 1800 can include one or more computing platforms 1802. Computing platform(s) 1802 can be configured to communicate with one or more remote platforms 1804 according to a client/server architecture, a peer-to-peer architecture, and/or other architectures. Remote platform(s) 1804 can be configured to communicate with other remote platforms via computing platform(s) 1802 and/or according to a client/server architecture, a peer-to-peer architecture, and/or other architectures. Users can access computing system 1800 via remote platform(s) 1804. According to some embodiments, one or more of computing platform(s) 1802, remote platform(s) 1804, and/or other components of computing system 1800 can be the same as or similar to one or more components of the computing system 10 of FIG. 1, the computing system 300 of FIG. 2, and/or other computing resources disclosed herein.

Computing platform(s) 1802 can be configured by machine-readable instructions 1806. Machine-readable instructions 1806 can include one or more instruction modules. The instruction modules can include computer program modules. The instruction modules can include one or more of 3D Data Module 1808, Patient Parameter Module 1810, Simulation Module 1812, Risk Analysis Module 1814, Results Module 1816 and/or other instruction modules.

3D Data Module 1808 can be configured to access 3D data regarding a dental prostheses for a patient, at the computing system 300 or 400. For example, as discussed herein, 3D data may be input or accessed from storage, and may include an STL file or other 3D mesh formats as input, for example.

STL is a file format native to the stereolithography CAD software created by 3D Systems, and the file extension is an abbreviation for stereolithography. An STL file describes a raw, unstructured triangulated surface by the unit normal and vertices (ordered by the right-hand rule) of the triangles using a three-dimensional Cartesian coordinate system. STL files contain no scale information, and the units are arbitrary. STL files describe only the surface geometry of a three-dimensional object without any representation of color, texture or other common CAD model attributes. The STL format specifies both ASCII and binary representations. Binary files are more common, since they are more compact. STL is widely used for rapid prototyping, 3D printing and computer-aided manufacturing, and supported by many other software packages

Patient Parameter Module 1810 can be configured to receive (e.g. as input) patient specific parameters related to the dental prostheses procedure, for example. Such patient specific parameters may include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, location/orientation of the dental prosthesis in relation to anatomical structures of the patient, and internal parameters including mechanical properties of bone, teeth and materials.

Simulation Module 1812 can be configured to perform a simulation of stresses and fatigue on the dental prostheses based upon the 3D data and patient specific parameters. Performing the simulation of stresses and fatigue on the dental prostheses preferably includes a finite element analysis (FEA) technique.

Risk Analysis Module 1814 can be configured to generate a risk analysis of the potential mechanical problems of the dental prostheses based upon the simulation of stresses, as discussed above. Generating the risk analysis may include generating a risk value on a probability scale of mechanical failure.

Results Module 1816 can be configured to output results of the risk analysis to a user to improve prosthetic design and materials selection, and manage quality control errors in manufacturing, which reduce the risk of mechanical problems, for example. Outputting results of the risk analysis may also include outputting corrective solutions and displaying quality control errors in manufacturing. The corrective solutions may include presenting alternative materials with lower risk values, suggesting dental prosthesis design changes, and displaying distortions in a finished dental prosthesis compared to a corresponding designed dental prosthesis.

External resources 1826 can include sources of information outside of computing system 1800, external entities participating with computing system 1800, and/or other resources. In some implementations, some or all of the functionality attributed herein to external resources 1826 can be provided by resources included in computing system 1800.

Computing platform(s) 1802 can include electronic storage 1830, one or more processors 1832, and/or other components. Computing platform(s) 1802 can include communication lines, or ports to enable the exchange of information with a network and/or other computing platforms. Illustration of computing platform(s) 1802 in FIG. 18 is not intended to be limiting. Computing platform(s) 1802 can include a plurality of hardware, software, and/or firmware components operating together to provide the functionality attributed herein to computing platform(s) 1802. For example, computing platform(s) 1802 can be implemented by a cloud of computing platforms operating together as computing platform(s) 1802.

Electronic storage 1830 can comprise non-transitory storage media that electronically stores information. The electronic storage media of electronic storage 1830 can include one or both of system storage that is provided integrally (i.e., substantially non-removable) with computing platform(s) 1802 and/or removable storage that is removably connectable to computing platform(s) 1802 via, for example, a port (e.g., a USB port, a firewire port, etc.) or a drive (e.g., a disk drive, etc.). Electronic storage 1830 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1830 can include one or more virtual storage resources (e.g., cloud storage, a virtual private network, and/or other virtual storage resources). Electronic storage 1830 can store software algorithms, information determined by processor(s) 1832, information received from computing platform(s) 1802, information received from remote platform(s) 1804, and/or other information that enables computing platform(s) 1002 to function as described herein.

Processor(s) 1832 can be configured to provide information processing capabilities in computing platform(s) 1802. As such, processor(s) 1832 can include one or more of a digital processor, an analog processor, a digital circuit designed to process information, an analog circuit designed to process information, a state machine, and/or other mechanisms for electronically processing information. Although processor(s) 1832 is shown in FIG. 18 as a single entity, this is for illustrative purposes only. In some implementations, processor(s) 1832 can include a plurality of processing units. These processing units can be physically located within the same device, or processor(s) 1832 can represent processing functionality of a plurality of devices operating in coordination. Processor(s) 132 can be configured to execute modules 1808-1824, and/or other modules. Processor(s) 1832 can be configured to execute modules by software; hardware; firmware; some combination of software, hardware, and/or firmware; and/or other mechanisms for configuring processing capabilities on processor(s) 1832. As used herein, the term “module” can refer to any component or set of components that perform the functionality attributed to the module. This can include one or more physical processors during execution of processor readable instructions, the processor readable instructions, circuitry, hardware, storage media, or any other components.

It should be appreciated that although modules 1808-1816 are illustrated in FIG. 2 as being implemented within a single processing unit, in implementations in which processor(s) 1832 includes multiple processing units, one or more of the modules can be implemented remotely from the other modules. The description of the functionality provided by the different modules described herein is for illustrative purposes, and is not intended to be limiting, as any of modules can provide more or less functionality than is described. For example, one or more of modules can be eliminated, and some or all of its functionality can be provided by other ones of modules. As another example, processor(s) 1832 can be configured to execute one or more additional modules that can perform some or all of the functionality attributed below to one of modules 1808-1816.

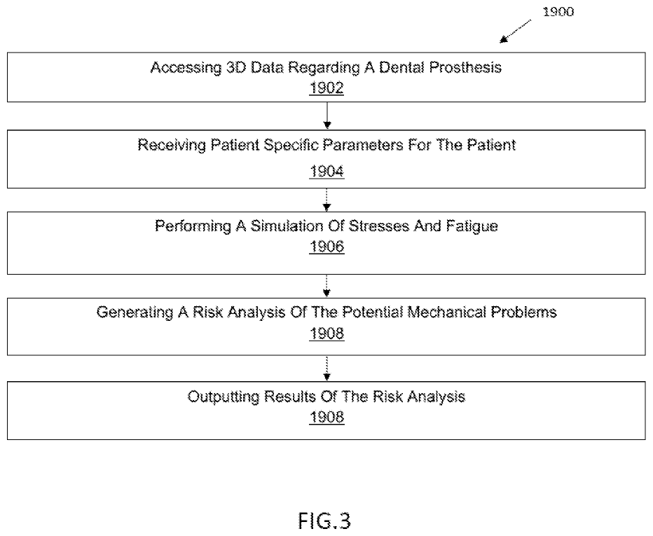

FIG. 3 is a flow chart showing functions of a method for providing the System and Method for dental prosthetic design and evaluation, in accordance with the example embodiments. FIG. 3 is a flow chart showing a set 1900 of functions of that can be carried out using the computing system 300 of FIG. 1, the computing system 1800 of FIG. 2, the computing platform(s) 1802, the remote platform(s) 1804, and/or other computing resources. A method of the example embodiments can include one or more functions of the set 1900 and/or a portion of one or more functions of the set 1900. Additionally, the order in which the functions of set 1900 are illustrated in FIG. 3 and described below is not intended to be limiting.

Accordingly, a method based on function(s) of the set 1900 can include a computer-implemented method involving a software application executed by the computing system (e.g., computing system 300 of FIG. 1), the computing system 1800 of FIG. 2, the computing platform(s) 1802, the remote platform(s) 1804, and/or other computing resources) with and/or in communication with a display screen. The software application involves graphically displaying a user interface that may include information, selectable features, updates etc.

FIG. 3 illustrates set 1900. Block 1902 includes accessing 3D data regarding a dental prosthesis for a patient. The functions of block 1902 can be performed by one or more hardware processors configured by machine-readable instructions including the 3D Data Module 1808, in accordance with the example embodiments.

Block 1904 includes receiving patient specific parameters for the patient. The functions of block 1904 can be performed by one or more hardware processors configured by machine-readable instructions including a module that is the same as or similar to Patient Parameter Module 1810, in accordance with the example embodiments.

Block 1906 includes performing a simulation of stresses and fatigue on the dental prostheses based upon the 3D data and patient specific parameters. The functions of block 1906 can be performed by one or more hardware processors configured by machine-readable instructions including a module that is the same as or similar to Simulation Module 1812, in accordance with the example embodiments.

Block 1908 includes generating a risk analysis of the potential mechanical problems of the dental prostheses based upon the simulation of stresses and fatigue. The functions of block 1908 can be performed by one or more hardware processors configured by machine-readable instructions including a module that is the same as or similar to Risk Analysis Module 1814, in accordance with the example embodiments.

Block 1910 includes outputting results of the risk analysis to a user to improve prosthetic design and materials selection, and reduce the risk of mechanical problems. The functions of block 1910 can be performed by one or more hardware processors configured by machine-readable instructions including a module that is the same as or similar to Results Module 1816, in accordance with the example embodiments.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A computing system to analyse risks of potential mechanical problems of dental prostheses, the system comprising:
one or more hardware processors and associated memory configured by machine-readable instructions to:
access 3D data regarding a dental prostheses for a patient;
receive patient specific parameters for the patient;
perform a simulation of stresses and fatigue on the dental prostheses based upon the 3D data and patient specific parameters;
generate a risk analysis of the potential mechanical problems of the dental prostheses based upon the simulation of stresses; and
output results of the risk analysis to a user to improve prosthetic design and materials selection, and manage quality control errors in manufacturing, which reduce the risk of mechanical problems.

2. The computing system of claim 1, wherein performing the simulation of stresses and fatigue on the dental prostheses comprises a finite element analysis (FEA) technique.

3. The computing system of claim 2, wherein the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, location/orientation of the dental prosthesis in relation to anatomical structures of the patient.

4. The computing system of claim 3, wherein the FEA technique further uses internal parameters including mechanical properties of bone, teeth and materials.

5. The computing system of claim 1, wherein generating the risk analysis includes generating a risk value on a probability scale of mechanical failure.

6. The computing system of claim 1, wherein outputting results of the risk analysis further includes outputting corrective solutions and displaying quality control errors in manufacturing.

7. The computing system of claim 6, wherein the corrective solutions include presenting alternative materials with lower risk values, suggesting dental prosthesis design changes, and displaying distortions in a finished dental prosthesis compared to a corresponding designed dental prosthesis.

8. A method to analyse risks of potential mechanical problems of dental prostheses, using one or more hardware processors and associated memory configured by machine-readable instructions, the method comprising:
accessing 3D data regarding a dental prostheses for a patient;
receiving patient specific parameters for the patient;
performing a simulation of stresses and fatigue on the dental prostheses based upon the 3D data and patient specific parameters;
generating a risk analysis of the potential mechanical problems of the dental prostheses based upon the simulation of stresses and fatigue; and
outputting results of the risk analysis to a user to improve prosthetic design and materials selection, and reduce the risk of mechanical problems.

9. The method of claim 8, wherein performing the simulation of stresses and fatigue on the dental prostheses comprises a finite element analysis (FEA) technique.

10. The method of claim 9, wherein the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, location/orientation of the dental prostheses in relation to anatomical structures of the patient.

11. The method of claim 10, wherein the FEA technique further uses internal parameters including mechanical properties of bone, teeth and materials.

12. The method of claim 8, wherein generating the risk analysis includes generating a risk value on a probability scale of mechanical failure.

13. The method of claim 8, wherein outputting results of the risk analysis further includes outputting corrective solutions and displaying quality control errors in manufacturing.

14. The method of claim 8, wherein the corrective solutions include presenting alternative materials with lower risk values, suggesting dental prosthesis design changes, and displaying distortions in a finished dental prosthesis compared to a corresponding designed dental prosthesis.

15. A non-transitory computer-readable memory having stored therein instructions executable by a processor to cause a computing system to perform functions comprising:
accessing 3D data regarding a dental prostheses for a patient;
receiving patient specific parameters for the patient;
performing a simulation of stresses and fatigue on the dental prostheses based upon the 3D data and patient specific parameters;
generating a risk analysis of the potential mechanical problems of the dental prostheses based upon the simulation of stresses and fatigue; and
outputting results of the risk analysis to a user to improve prosthetic design and materials selection, and reduce the risk of mechanical problems.

16. The transitory computer-readable memory of claim 15, wherein performing the simulation of stresses and fatigue on the dental prostheses comprises a finite element analysis (FEA) technique.

17. The transitory computer-readable memory of claim 16, wherein the patient specific parameters include one or more of desired prosthetic materials, biteforce data, jaw motion tracking data, dental implant number, type and location/orientation data, implant abutments used, abutment and prosthetic screws used, bonding agents used, prepared teeth to be used to retain the dental prosthesis, and location/orientation of the dental prostheses in relation to a temporomandibular joint of the patient.

18. The transitory computer-readable memory of claim 17, wherein the FEA technique further uses internal parameters including mechanical properties of bone, teeth and materials.

19. The transitory computer-readable memory of claim 15, wherein generating the risk analysis includes generating a risk value on a probability scale of mechanical failure and displaying quality control errors in manufacturing.

20. The transitory computer-readable memory of claim 15, wherein outputting results of the risk analysis further includes outputting corrective solutions that include presenting alternative materials with lower risk values, suggesting dental prosthesis design changes, and displaying distortions in a finished dental prosthesis compared to a corresponding designed dental prosthesis.
